(19) United States
(12) Patent Application Publication
(10) Pub. No.: US 2009/0327002 A1
(43) Pub. Date: Dec. 31, 2009

(54) AUTOMATED WORKFLOW FOR CONTENT LOCALIZATION MANAGEMENT

(75) Inventors: Helena Shih Chapman, Wellesley, MA (US); Angshuman Deb, Sunnyvale, CA (US); Francis X. Rojas, Austin, TX (US)

Correspondence Address: LAW OFFICE OF DONALD L. WENSKAY, P.O. Box 7206, Rancho Santa Fe, CA, 92067, US

(73) Assignee: International Business Machines Corporation, Armonk, NY (US)

(21) Appl. No.: 12/165,567

(22) Filed: Jun. 30, 2008

(51) Int. Cl. G06F 17/00; G06Q 10/00

(52) U.S. Cl. 705/7; 707/102; 707/E17.005

(57) ABSTRACT

According to one embodiment of the present invention, a method for automating content localization workflow including translation processes. The method includes generating initial metadata relating to the status of a content localization workflow. The current status of the metadata is determined and displayed on a user interface dashboard. The user interface dashboard may be used to modify the content localization workflow. The metadata is used to drive changes and interaction from one phase of the workflow to another in an automated manner.

### BACKGROUND

The present invention relates to content localization, and more specifically, to automated workflow systems for the management of content localization processes.

The expansion of businesses and markets worldwide has created a business environment with economic interdependencies, global operations, workforce mobility and global regulations. This process has been accelerated by the internet, which operates seamlessly across national and geographic boundaries. The impact on the computer industry has been to require computer software and web sites to adapt to non-native environments, such as other nations and cultures. Globalization of computer products, such as software and web sites, involves both internationalization and localization of software. Internationalization is the process of designing a software application so that it can be adapted to various languages and regions without engineering changes. Localization is the process of adapting software for a specific region or language by adding locale-specific components and translated text.

Localization of content, whether the content relates to software or publication, is generally done at the tail end of a product creation life cycle. From planning to delivery, the consideration for localization is sometimes an after-thought as the products are getting ready for general availability. The localization industry and service providers approach specific topics or phases of the entire localization process with point-to-point solutions assembled together with loose integration in between. As a result, organizations are faced with the challenges to provide sufficient manual project management resources to ensure that localization investments deliver the expected results.

### SUMMARY

According to one embodiment of the present invention, a method comprises: generating initial metadata relating to the status of a content localization workflow; determining the current status of the metadata; displaying the status of the metadata in a user interface; and using the user interface to modify the content localization workflow.

According to another embodiment of the present invention, a method comprises: generating a plan for a content localization process by using a requestor planning application in a planning subsystem; generating metadata regarding the plan; authoring content to be localized in the content localization process using an authoring system and a content management system; validating the authored content through a common content access interface unit; receiving the content form a common metadata access interface and translating the content; building the translated content in a centralized build environment to a format specified by the metadata; and delivering the content to a destination determined by the metadata.

According to a further embodiment of the present invention, a system comprises: a metadata state controller for receiving initial metadata relating to a content localization process and for responding to changes in the metadata; a metadata connector interface for providing connection services between the meta data state controller and a content system; and a dashboard user interface for displaying real time status of the content localization process and permitting user changes to the process.

According to another embodiment of the present invention, a computer program product for managing content localization comprises: a computer usable medium having computer usable program code embodied therewith, the computer usable program code comprising: computer usable program code configured to: generate initial metadata relating to the status of a content localization workflow; determine the current status of the metadata; display the status of the metadata in a user interface; and use the user interface to modify the content localization workflow.

### BRIEF DESCRIPTION OF THE SEVERAL VIEWS OF THE DRAWINGS

FIG. 1 is a diagram of a typical content localization life-cycle;

FIG. 2 is a diagram of a content localization management system in accordance with an embodiment of the invention;

FIG. 3 is a diagram illustrating exemplary interactions between a content metadata controller and both a content system and a set of enterprise resources in accordance with an embodiment of the invention;

FIGS. 4a and 4b are diagrams of a content localization management system in accordance with an embodiment of the invention;

FIG. 5 is a diagram of the generic phases of an end-to-end localization process;

FIGS. 6a and 6b are diagrams of user interface screens for a plurality of localization projects;

FIGS. 7a and 7b are diagrams of user interface screens for a publish translation localization project; and

FIG. 8 shows a high level block diagram of an information processing system useful for implementing one embodiment of the present invention.

### DETAILED DESCRIPTION

Embodiments of the invention provide an automated workflow system for agile content localization management. These embodiments provide an end-to-end data-driven system with well defined process tasks. Changes in metadata attributes drive the flow of the localization life cycle and not humans. The present invention can choreograph and manage the different phases of the localization process and in turn trigger the required process activities outside the localization environment. It accomplishes this by allowing metadata to drive the changes and interaction from one phase to another in an automated fashion. The present invention has enough flexibility to allow different subsystems to work directly with the end-to-end process that manages the entire life cycle. In this way the present invention may eliminate unnecessary human intervention in managing content localization.

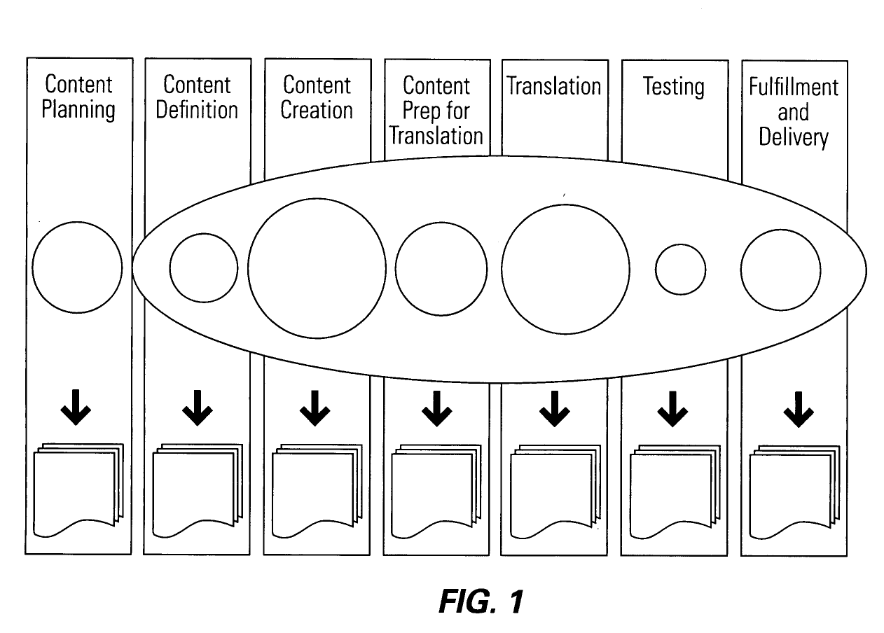

Referring now to FIG. 1, a typical localization life cycle is shown. There are deliverables associated with each phase of the life cycle. The various sizes of shapes in the oval represent the activity level of the phases. For example, content creation and translation usually requires the most work effort, are the most labor intensive, and are the most costly during the life cycle.

A software business process is generally utilized to provide the basic methodology for defining, developing, qualifying, delivering, and supporting an offering over its life cycle. When executed with other key supporting processes and sub-processes, it provides an approach for developing competitive, high-quality offerings that the marketplace wants in a timely manner. The concept of business process management (BPM) is applied at many software institutions. Current BPM software helps organizations optimize and automate key business processes and move information from one process to another smoothly.

One type of BPM is the content management system (CMS), which is a system used to manage content within a business, e.g. Web site content, software programming information, publications, electronic documents, audio/video files and so on. Companies may use a CMS to share files or promote collaborative creation of documents. CMS may support the definition of workflow tasks. This feature is often coupled with event messaging/notification processes so that content owners can be alerted to any changes. In one aspect of the present invention, a CMS is combined with other BPM systems to help drive automated management of content localization in an on-demand fashion.

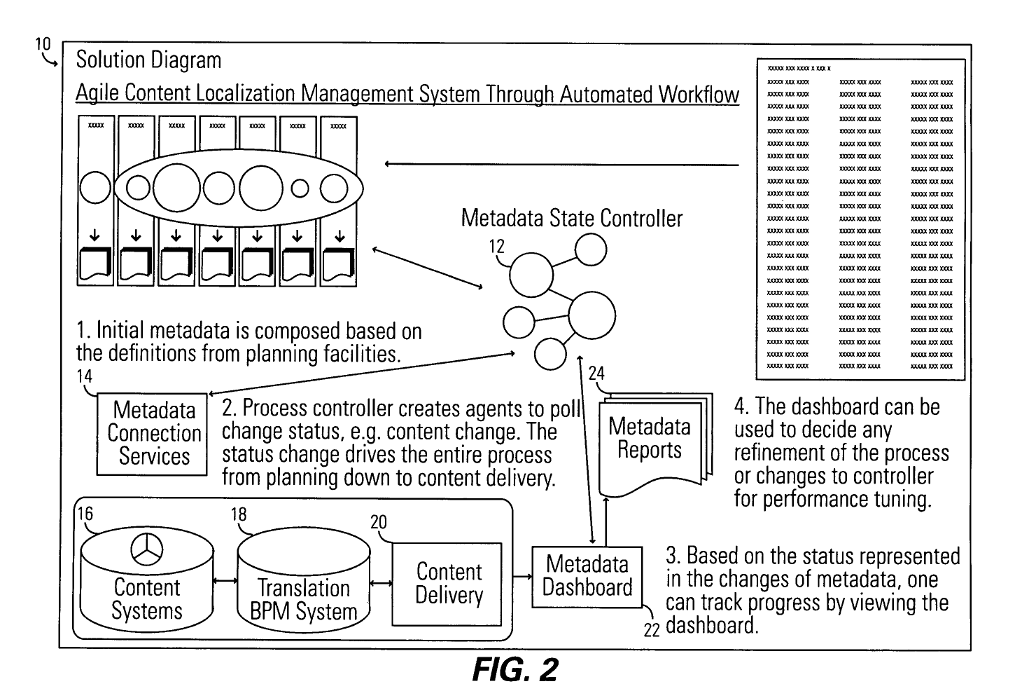

Referring now to FIG. 2 there is shown an automated, metadata driven, localization process management system 10 in accordance with an embodiment of the invention. The system 10 can automatically perform the four following processes: 1) connect content artifacts to end-to-end business operation systems automatically; 2) automatically identify artifact changes in content and localization status and trigger appropriate actions in any subsystem e.g. CMS or BPM; 3) dynamically generate a metadata artifact for data exchange between subsystems; and 4) allow real-time translation related business decision making using a dynamic metadata viewing dashboard for easy management of changes in localization value chain process.

The system 10 includes a metadata state controller 12 that receives initial metadata based on definitions from various planning facilities. The metadata state controller 12 also manages changes in any subsystem and automatically triggers the appropriate subsequent actions. In addition, the metadata state controller 12 creates agents to poll change status, which may comprise, for example, changes in the content. Status changes are used by the metadata state controller 12 to drive the entire process throughout each of the above-discussed seven phases of the localization life-cycle.

The system 10 includes a metadata connector interface 14 which performs metadata connection services, by allowing hook-up to any metadata sources or destinations, such as CMS or Globalization Management System (GMS). For example the metadata connector interface 14 may provide connection services between the metadata state controller and content systems 16, a translation BPM system 18, and a content delivery system 20.

The system 10 also includes a user interface called a metadata dashboard 22 that enables the management of metadata for real time business decision making. Based on the status represented in the changes of metadata, a user can track progress by viewing the metadata dashboard 22. The metadata dashboard 22 can be used to decide any refinement of the process or changes to the metadata state controller 12 for performance tuning. The metadata dashboard 22 may also be used to generate metadata reports 24 that may be used by the planning facilities associated with the seven localization phases.

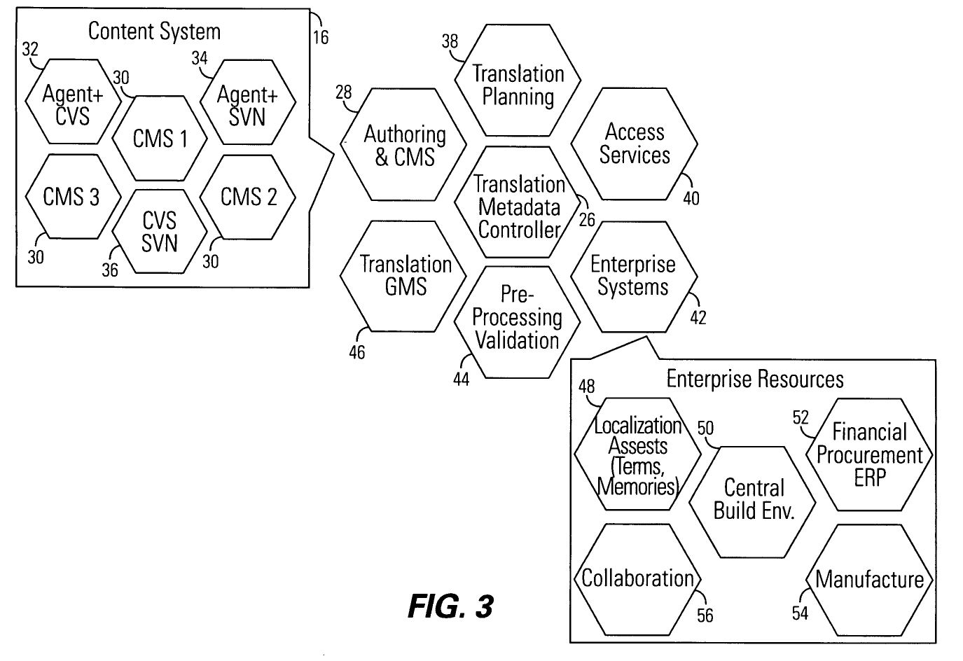

At each phase of the localization process significant amounts of manual labor and time may be saved by abstracting and delivering information which is delivered as information to drive the next phase of the localization process activities. FIG. 3, shows a conceptual view of the activities of a transaction metadata controller 26, which is part of the metadata state controller 12.

An authoring and CMS services unit 28, which is part of the metadata connector interface 14, defines the connections to various content systems 16. In the embodiment shown in FIG. 3, these content systems include content management systems 30, an agent+concurrent version system (CVS) unit 32, an agent+subversion (SVN) unit 34, and a CVS SVN unit 36. The CMS metadata definition aligns with the translation metadata controller 26 to allow for connection to as many content systems as possible. In particular, this is accomplished by means of the connector interface between the authoring and CMS services unit 28 and the content system 16. This connector interface is basically a sub-service of the access services unit 40. The translation metadata controller 26 manages the meta-data changes within the system to decide how the entire system 10 should react to the changes. The translation metadata controller 26 can be considered to be an event dispatcher and the engine that drives the activities while other components either perform the actual activity, or subsequently create a meta-data change to trigger the next step in the process in a different component. These other components also include a translation planning unit 38, enterprise systems 42, a pre-processing validation unit 44, and a translation GMS 46.

The enterprise systems 42 may include enterprise resources such as localization assets 48, central build unit 50, financial procurement enterprise resource planning (ERP) unit 52, manufacturing systems 54, and collaboration systems 56. The metadata may also connect to additional enterprise resources such as terminology data, memory management and other services.

For example, when the content in CMS 1 30 changes and indicates that some content is created and ready for translation, an automatic workflow gets kicked off based on that metadata change. The pre-processing validation service 44 then takes over and initiates the automatic validation of material before it is sent to translation vendors. Once the validation service is completed, the metadata then indicates the need to prepare information and package the material. The metadata also indicates the required resources such as previous translation memory and required metadata to drive the next phase of the translation process.

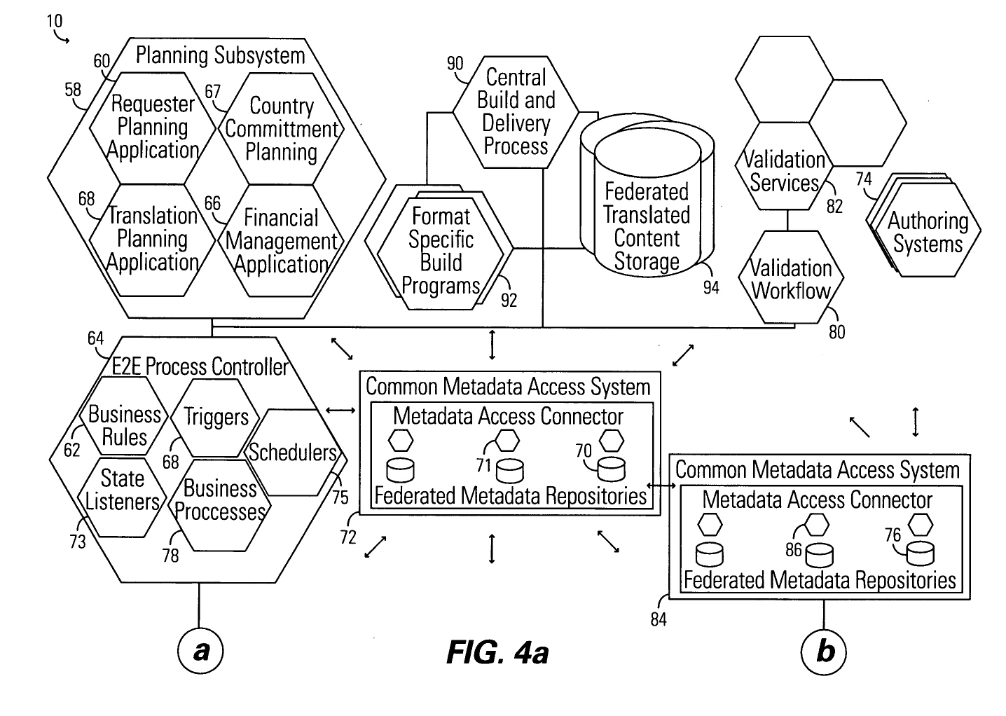

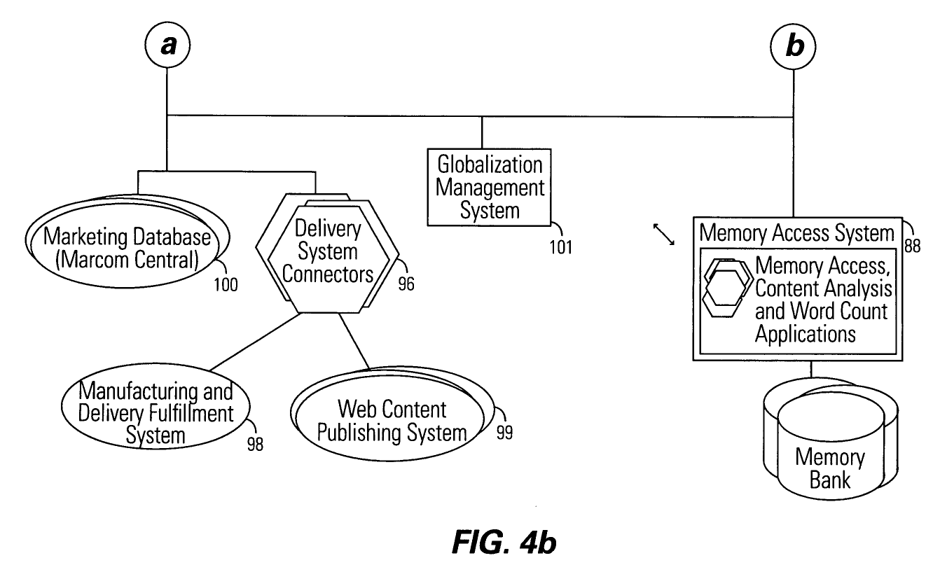

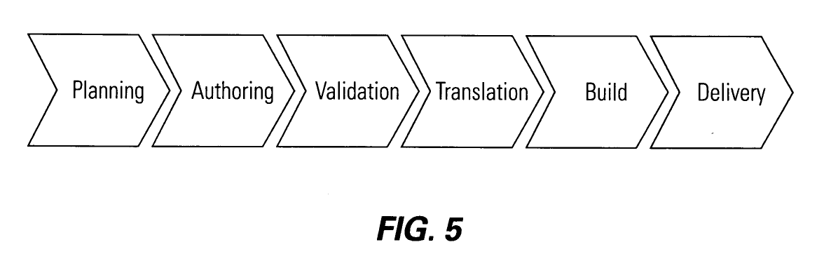

Referring now to FIGS. 4a, 4b and 5, additional details of one embodiment of the system 10 are shown. In FIG. 5, in one embodiment, the end-to-end process can be broken down into six generic phases: Planning; Authoring; Validation; Translation; build, and Delivery.

During the Planning phase, the planning subsystem 58 uses a knowledge-based requester planning application wizard 60 to assist creating iterative development plans and topic re-use. A globalization planner (not shown) in the planning subsystem 58 uses the requester planning application wizard 60 to add globalization details to the plans and its constituent consumable units and work units, using a pre-defined business rules unit 62 in an end-to-end process controller 64. A knowledge wizard, such as a translation planning application 68 in the planning subsystem 58 may be used to assist a user, such as a Country Marketing Manager in making translation commitment decisions. Another user, such as a Financial Planner, may use a financial management application 66 to manage the financial pipeline and transactions with a translation vendor organization. Planning subsystem 58 may also include a country commitment planning unit 67. Triggers 65 in the end-to-end process controller 64 are used to automatically trigger the metadata state controller 12 to respond to changes in any part of the system 10. The end-to-end process controller may also include state listeners 73 and schedulers 75.

The metadata generated about the plan and its constituent elements at this phase is persisted across different metadata repositories and used to drive the downstream processes. These metadata repositories may include federated metadata repositories 70 in a common metadata access system 72.

During the Authoring phase, a user, such as an Information Developer, may use the authoring tools to create content. For example, the authoring tools may include authoring systems 74. The Information Developer may also use the different content management systems 16, including federated content management systems 76, to persist the content as well as to maintain the different life-cycle workflows/processes relevant to a specific authoring process.

A Submission phase employs specific business processes 78 with human and automated checks to test the readiness of the content according to pre-defined business rules 62. One of the tasks within the Submission phase is validation, shown in FIG. 5. During Validation, in the embodiment shown in FIG. 4, content created by authoring system 74 will go through a validation workflow unit 80 which will invoke validation services unit 82 after information is retrieved using the common content access system 84 as requested by authoring system 74. If the results of invoking the validation services unit 82 are not good, the content will be submitted and sent back to authoring systems 74 for corrections. Content which successfully passes the readiness checks get submitted for the Translation phase. It may be noted that, for a given business unit, the manager of that unit may decide that only a subset of the checks need to be performed for a given line of products. Alternatively, the manager may decide that more checks need to be carried out for other products. This process should be driven by pre-defined business rules that get updated on a periodical basis as the business units change strategy and directions. Therefore, the business rules unit 62 can be changed to perform a different set of checks in 82 for validation.

During the Translation phase, the translation vendor receives the content, associated historical memory segments, translation instructions, and other metadata from a Requestor. The content access connector 86 and the memory access interface 88 are used to extract content and previous memory segments relevant to a specific shipment. Metadata delivered through the federated metadata access connector 71 drives the submission as well as the Translation phase. In the Translation phase, the translators translate the content over several iterations.

After the Translation phase in the Build phase, the translated content is built in a centralized build environment to format(s) (web, pdf, eclipse plug-in, etc) committed during the planning phase. For example, this may be done by a central build and delivery process 90 using format specific build programs 92 and a federated translated content storage unit 94.

At the end of the Build phase, in the Delivery phase, the transformed content in the federated translated content storage 94 is pushed through different delivery channels, again utilizing the delivery metadata captured in earlier phases. For example, delivery system connectors 96 connected to the common metadata access system 72 may deliver the content to a manufacturing and fulfillment system 98. A plurality of delivery system connectors 96 may also be connected to a web content publishing system 99 and a marketing database 100. A globalization management system (GMS) 101, is basically the business process management system that handles all the content localization requirements and needs after the content is created and ready for translation. The GMS 101 performs the function of translation memory analysis (to prevent re-translate the words that have been translated in the previous releases), terminology analysis, any approval or communication process that would usually be done by humans thru automation (and only handle the exception cases) and so on.

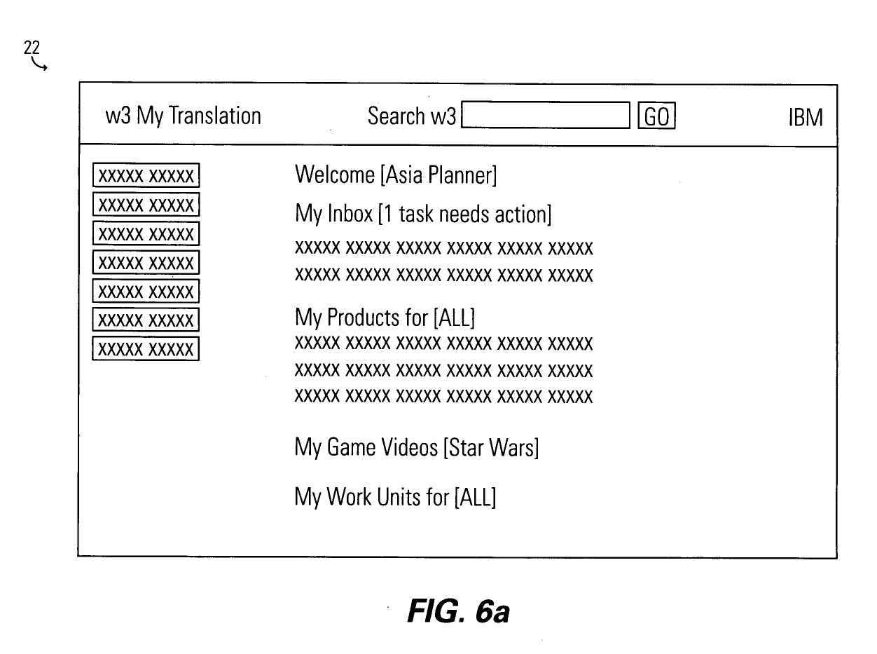

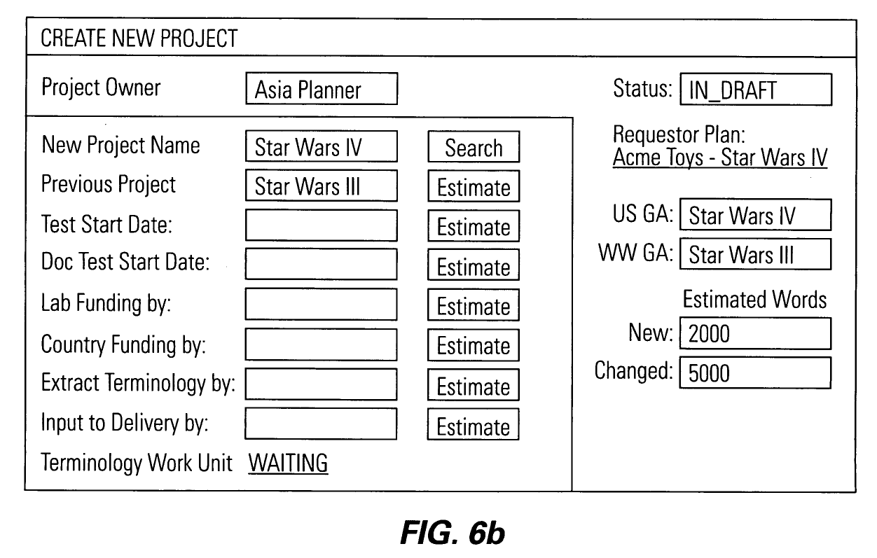

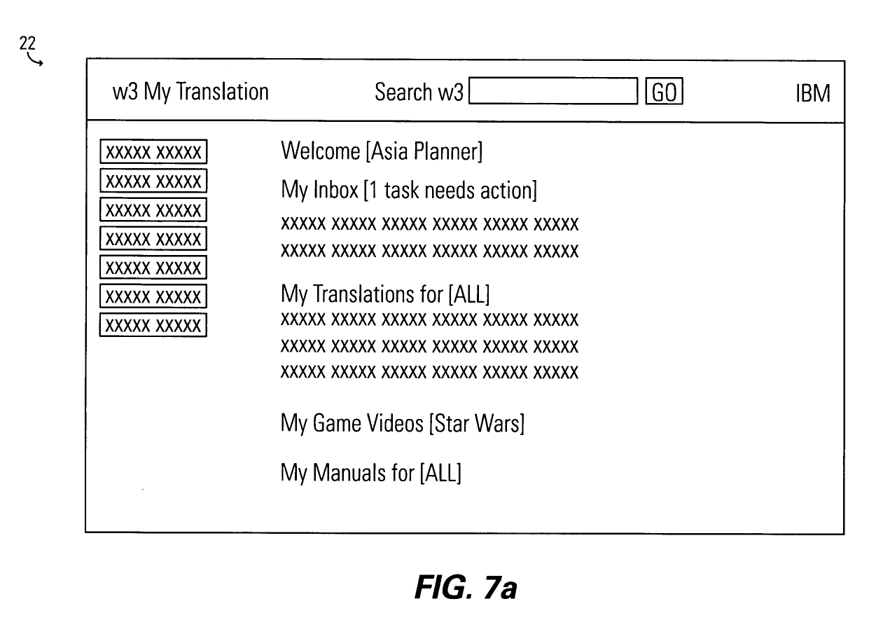

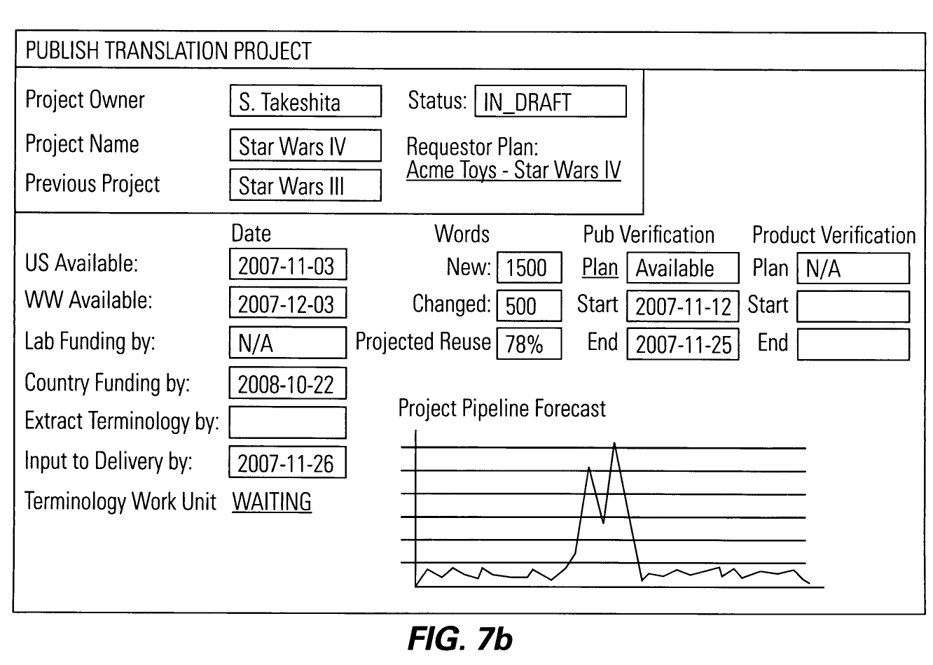

An example of the metadata dashboard 22 shown in FIG. 2 is illustrated in FIGS. 6a, 6b, 7a and 7b. In this embodiment, the metadata dashboard 22 outlines the progress of any translation activities and associated metadata. As shown in FIGS. 6a and 6b, the “Asia Planner” uses the meta-data dashboard to view all product and localization demand metadata including: 1) My Products for [ALL], which identifies the products and key milestones; 2) My Game Videos [Star Wars], which identifies specific video games relating to Star War products; 3) My Manuals for [ALL], which identifies the information content needed for the Game Videos selected. The Asia Planner also sees tasks to create a new translation plan for Star Wars IV games, as shown in the Create New Project window in FIG. 6b.

The dashboard 22 is also able to see the pipeline of localization demand as shown in FIGS. 7a and 7b. Specifically, the “PUBLISH TRANSLATION PROJECT”, shown in FIG. 7b shows the key dates as well as the “Project Pipeline Forecast” that highlights the demand of translation/localization work thru the life of the product.

As can be seen from the above disclosure, embodiments of the invention provide a fully automated workflow process that can eliminate typical manual actions required during typical content translation activities. Embodiments of the invention may also provide a comprehensive meta-data viewer to enable customization to business unit requirements and real time business decision making. The result is a service oriented translation infrastructure that allows for smooth adaptation to any trusted data sources or destinations.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wire line, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

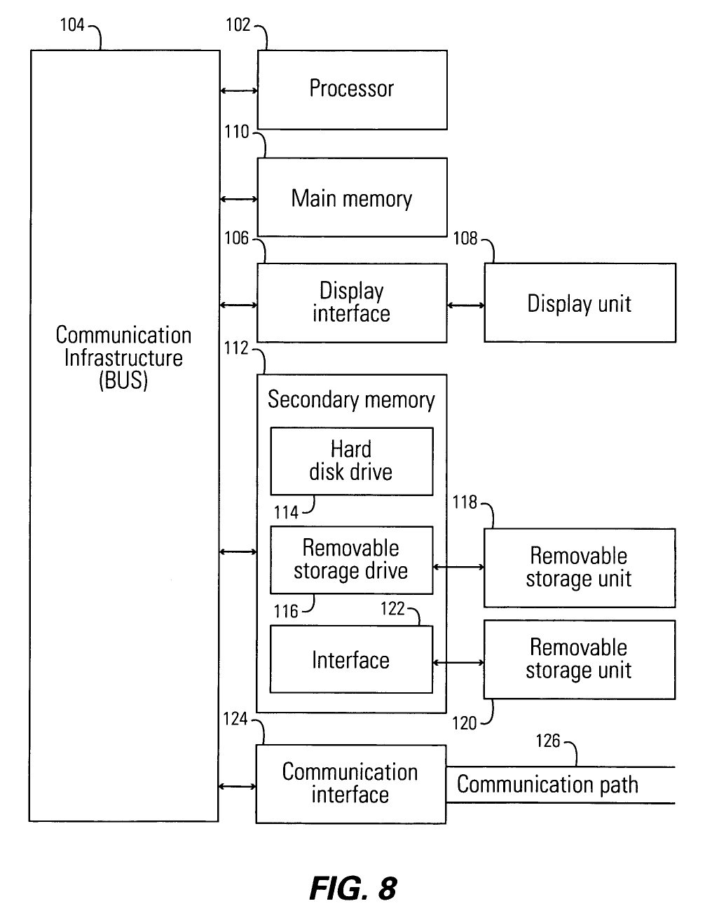

FIG. 8 is a high level block diagram showing an information processing system useful for implementing one embodiment of the present invention. The computer system includes one or more processors, such as processor 102. The processor 102 is connected to a communication infrastructure 104 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 106 that forwards graphics, text, and other data from the communication infrastructure 104 (or from a frame buffer not shown) for display on a display unit 108. The computer system also includes a main memory 110, preferably random access memory (RAM), and may also include a secondary memory 112. The secondary memory 112 may include, for example, a hard disk drive 114 and/or a removable storage drive 116, representing, for example, a floppy disk drive, a magnetic tape drive, or an optical disk drive. The removable storage drive 116 reads from and/or writes to a removable storage unit 118 in a manner well known to those having ordinary skill in the art. Removable storage unit 118 represents, for example, a floppy disk, a compact disc, a magnetic tape, or an optical disk, etc. which is read by and written to by removable storage drive 116. As will be appreciated, the removable storage unit 118 includes a computer readable medium having stored therein computer software and/or data.

In alternative embodiments, the secondary memory 112 may include other similar means for allowing computer programs or other instructions to be loaded into the computer system. Such means may include, for example, a removable storage unit 120 and an interface 122. Examples of such means may include a program cartridge and cartridge interface (such as that found in video game devices), a removable memory chip (such as an EPROM, or PROM) and associated socket, and other removable storage units 120 and interfaces 122 which allow software and data to be transferred from the removable storage unit 120 to the computer system.

The computer system may also include a communications interface 124. Communications interface 124 allows software and data to be transferred between the computer system and external devices. Examples of communications interface 124 may include a modem, a network interface (such as an Ethernet card), a communications port, or a PCMCIA slot and card, etc. Software and data transferred via communications interface 124 are in the form of signals which may be, for example, electronic, electromagnetic, optical, or other signals capable of being received by communications interface 124. These signals are provided to communications interface 124 via a communications path (i.e., channel) 126. This communications path 126 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 110 and secondary memory 112, removable storage drive 116, and a hard disk installed in hard disk drive 114.

Computer programs (also called computer control logic) are stored in main memory 110 and/or secondary memory 112. Computer programs may also be received via communications interface 124. Such computer programs, when executed, enable the computer system to perform the features of the present invention as discussed herein. In particular, the computer programs, when executed, enable the processor 102 to perform the features of the computer system. Accordingly, such computer programs represent controllers of the computer system.

From the above description, it can be seen that the present invention provides a system, computer program product, and method for implementing the various embodiments of the invention. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
generating initial metadata relating to the status of a content localization workflow;
determining the current status of said metadata;
displaying the status of said metadata in a user interface; and
using said user interface to modify said content localization workflow.

2. A method according to claim 1 wherein said metadata includes information relating to content being localized by said content localization workflow and wherein said determining includes determining changes to said content.

3. A method according to claim 2 wherein said determining comprises using a metadata process controller to determine changes in said metadata.

4. A method according to claim 3 wherein said determining comprises using said metadata process controller to create agents to poll changes in said metadata.

5. A method according to claim 3 further comprising using said metadata process controller to control content management systems.

6. A method according to claim 1 further comprising:
transferring metadata from one phase of said content localization workflow to a subsequent phase of said content localization workflow; and
using said metadata in said subsequent phase of said content localization workflow.

7. A method comprising:
generating a plan for a content localization process by using a requester planning application in a planning subsystem;
generating metadata regarding said plan;
authoring content to be localized in said content localization process using an authoring system and a content management system;
validating said authored content through a common content access interface unit;
receiving said content form a common metadata access interface and translating said content;
building said translated content in a centralized build environment to a format specified by said metadata; and
delivering said content to a destination determined by said metadata.

8. A method according to claim 7 wherein said planning comprised using predefined business rules in a process controller to add globalization details to said plan.

9. A method according to claim 7 further comprising determining if said content has changed and modifying said metadata in response to said change.

10. A method according to claim 7 further comprising generating a user interface dashboard and generating changes in said content localization process using said dashboard.

11. A system comprising:
a metadata state controller for receiving initial metadata relating to a content localization process and for responding to changes in said metadata;
a metadata connector interface for providing connection services between said meta data state controller and a content system; and
a dashboard user interface for displaying real time status of said content localization process and permitting user changes to said process.

12. A system according to claim 11 further comprising agents generated by said metadata state controller for polling change status throughout said system,

13. A system according to claim 11 further comprising a common metadata access system for allowing access to said metadata by subsystems of said system.

14. A system according to claim 13 wherein said subsystems comprise:
an authoring subsystem;
a validation workflow subsystem;
a common content access system for managing information flowing to and from said authoring subsystem and said validation workflow subsystem.

15. A system according to claim 11 further comprising a memory access interface for providing access to stored content.

16. A system according to claim 14 further comprising a federated content management system included in said common content access system.

17. A system according to claim 13 further comprising a federated metadata repository included in said common metadata access interface.

18. A system according to claim 13 wherein said subsystems include a planning subsystem.

19. A system according to claim 18 wherein said planning subsystem comprises a requester planning application.

20. A system according to claim 13 wherein said subsystems include an end-to-end process controller.

21. A system according to claim 20 wherein said end-to-end process controller includes a business processes component.

22. A computer program product for managing content localization, said computer program product comprising:
a computer usable medium having computer usable program code embodied therewith, said computer usable program code comprising:
computer usable program code configured to:
generate initial metadata relating to the status of a content localization workflow;
determine the current status of said metadata;
display the status of said metadata in a user interface; and
use said user interface to modify said content localization workflow.

23. A computer program product according to claim 22 wherein said metadata includes information relating to content being localized by said content localization workflow and wherein said determining includes determining changes to said content.

24. A computer program product according to claim 22 wherein said computer usable program code is further configured to use a metadata process controller to determine changes in said metadata.

25. A computer program product according to claim 22 wherein said computer usable program code is further configured to use said metadata process controller to control content management systems.
